(19) United States
(12) Patent Application Publication
(10) Pub. No.: US 2010/0248558 A1
(43) Pub. Date: Sep. 30, 2010

(54) Probe Connector

(76) Inventors: Te-Hung Yin, Taipei Hsien (TW); Jui-Pin Lin, Taipei Hsien (TW); Yung-Yi Chen, Taipei Hsien (TW)

Correspondence Address: LIN & ASSOCIATES INTELLECTUAL PROPERTY, INC., P.O. BOX 2339, SARATOGA, CA, 95070-0339, US

(21) Appl. No.: 12/413,515

(22) Filed: Mar. 27, 2009

(51) Int. Cl. H01R 13/24

(52) U.S. Cl. 439/824

(57) ABSTRACT

A probe connector has a barrel including a main body and a base integrally connected with one end of the main body. A holding portion is protruded inwards from an inner surface of the main body to form a first holding recess, adjacent to the base. A plunger includes a basic portion restricted in the barrel and a contact portion extended from one end of the basic portion and exposed from the other end of the barrel opposite to the base. The basic portion has a second holding recess at the other end thereof and coaxial with the first holding recess when the plunger is mounted to the barrel. An elastic element arranged inside the barrel has two ends respectively held by the first holding recess and the second holding recess to shorten an unrestrained part of the elastic element for reducing a resilient distortion of the elastic element.

### BACKGROUND OF THE INVENTION

1. Field of the Invention

The present invention relates to a probe connector, and particularly to a probe connector having a structure capable of prolonging the use lifetime of an elastic element thereof.

2. The Related Art

A conventional probe connector includes a barrel, an elastic element received in the barrel, a plunger mounted to the barrel and a base. The barrel defines a chamber which has an inner diameter larger than an outer diameter of the elastic element. The plunger is movably received in the chamber of the barrel and supported by the elastic element, with a tip end exposed from an upper opening of the barrel to contact an outer electrical device. The base is secured in a lower opening of the barrel to block the elastic element. Generally, in use, the elastic element is compressed and distorted to provide a supporting force which supports the plunger for balancing the lateral force with the outer electrical device. However, since the elastic element is distorted seriously and repeatedly in use, the resilience of the elastic element becomes worse and worse, which affects the stable connection between the probe connector and the outer electrical device and reducing the use lifetime of the elastic element.

### SUMMARY OF THE INVENTION

Accordingly, an object of the present invention is to provide a probe connector having a structure capable of prolonging the lifetime of an elastic element thereof and improving the connection stability. The probe connector has a barrel including a main body and a base integrally connected with one end of the main body to form a single piece. A holding portion is protruded inwards from an inner surface of the main body to form a first holding recess, adjacent to the base. A plunger includes a basic portion restricted in the barrel and a contact portion extended from one end of the basic portion and extends out of the barrel from the other end of the barrel opposite to the base for resisting an outer electrical device. The basic portion has a second holding recess at the other end thereof opposite to the contact portion and coaxial with the first holding recess when the plunger is mounted to the barrel. The elastic element is arranged inside the barrel. Two ends of the elastic element are respectively held by the first holding recess and the second holding recess to shorten an unrestrained part of the elastic element for reducing a resilient distortion of the elastic element when the plunger resists the outer electrical device

As described above, the first holding recess and the second holding recess are coaxial with each other and adapted for holding both ends of the elastic element to minimize the resilient distortion of the elastic element, which extends the use lifetime of the elastic element and keeps stable connection in use. In addition, the main body is integrated with the base, reducing the involved manufacturing cost and time.

### BRIEF DESCRIPTION OF THE DRAWING

The present invention will be apparent to those skilled in the art by reading the following description of a preferred embodiment thereof, with reference to the attached drawing, in which:

FIG. 1 is a plan view of a probe connector in accordance with the present invention.

### DETAILED DESCRIPTION OF THE PREFERRED EMBODIMENT

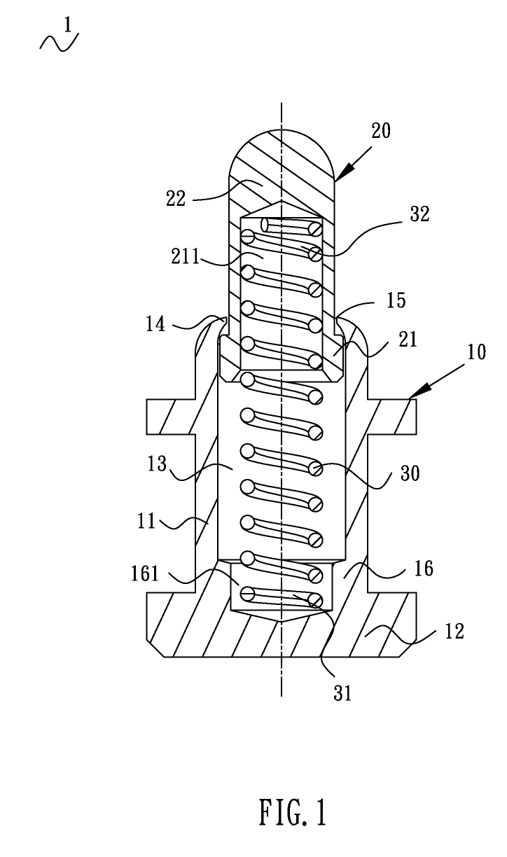

With reference to FIG. 1, a probe connector 1 of an embodiment in accordance with the present invention is shown. The probe connector 1 includes a hollow barrel 10, a plunger 20 and an elastic element 30 received in the barrel 10. The barrel 10 and the plunger 20 are made from metallic material.

The barrel 10 includes a cylindraceous main body 11 surrounding a chamber 13 therein, and a base 12 integrated with one end of the main body 11 to show a single piece. An inner surface of the main body 11 has a portion protruded inwards to form a holding portion 16 that adjoins the base 12. The holding portion 16 extends along a circumference of the inner surface of the main body 11, which surrounds a first holding recess 161 therein. The first holding recess 161, with a diameter thereof smaller than an inner diameter of the main body 11, is adapted for receiving an end of the elastic element 30. In this embodiment, the first holding recess 161 extends into the base 12 with a predetermined distance for increasing the inserted length of the elastic element 30. The other end of the main body 11, opposite to the base 12, is open and bent inwards to form a shoulder 14 after the plunger 20 is mounted to the barrel 10. An opening 15 is formed by the shoulder 14 for allowing the plunger 20 to pass therethrough, with a diameter thereof smaller than the inner diameter of the main body 11 for fixing the plunger 20 and the barrel 10.

The plunger 20 of cylindrical shape includes a basic portion 21 and a contact portion 22 extending outwards from one end of the basic portion 21. The basic portion 21 defines a second holding recess 211 at the other end thereof opposite to the contact portion 22. The second holding recess 211 is coaxial with the first holding recess 161 when the plunger 20 is mounted to the barrel 10 and spreads into the contact portion 22 with a predetermined distance for increasing the inserted length of the elastic element 30. The contact portion 22 is thinner than the basic portion 21, with a free end shaped as a dome. The basic portion 21 is received in the chamber 13 of the barrel 10 and the contact portion 22 extends out of the barrel 10 through the opening 15. The outer dimension of the basic portion 21 is less than the inner dimension of the main body 11 for allowing the basic portion 21 to be inclinably received in the chamber 13. The dimension of the opening 15 is less than the outer dimension of the basic portion 21 for preventing the basic portion 21 from removing out of the chamber 13. In this embodiment, the first holding recess 161, the second holding recess 211 and the chamber 13 are coaxial with one another.

The elastic element 30 arranged inside the main body 11 defines a first end 31 and a second end 32 opposite to the first end 31. The first end 31 and the second end 32 are mounted to the first holding recess 161 and the second holding recess 211, respectively. An unrestrained portion of the elastic element 30, between the holding portion 16 and the plunger 20, is distorted for making the plunger 20 contact the main body 11 when a lateral force is applied to the plunger 20.

Please refer to the FIG. 1 again, in assembly, the elastic element 30 is inserted into the chamber 13, with the first end 31 held in the first holding recess 161. The second end 32 of the elastic element 30 is inserted into the second holding recess 211 of the plunger 20. The basic portion 21 is restricted in the chamber 13 by the shoulder 14. When an outer electrical device (not shown) presses the plunger 20, the lateral force is provided to act the plunger 20 so that the plunger 20 moves toward the inside of the main body 11 and slants to contact the inner surface of the main body 11. Accordingly, the elastic element 30 is compressed and distorted to generate a counteracting force supporting the plunger 20. Since the first holding recess 161 and the second holding recess 211 hold the first end 31 and the second end 32 respectively, shortening the unrestrained length of the elastic element 30, the distortion of the elastic element 30 becomes less.

As described above, the first holding recess 161 and the second holding recess 211 are coaxial with each other and adapted for holding the first end 31 and the second end 32 in order to minimize resilient distortion of the elastic element 30, which extends the use lifetime of the elastic element 30 and keep stable connection between the plunger 20 and the outer electrical device in use. In addition, the main body 11 is integrated with the base 12, further reducing the involved manufacturing cost and time.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

1. A probe connector adapted for resisting an outer electrical device, comprising:
a barrel having a main body and a base integrally connected with a first end of the main body to form a single piece, a holding portion protruded inwards from an inner surface of the main body to form a first holding recess adjacent to the base, the first holding recess having a substantially cylindrical shape with a diameter smaller than an inner diameter of the main body;
a plunger including a basic portion restricted in the barrel and a contact portion extended from a first end of the basic portion and exposed from a second end of the main body opposite to the base for resisting the outer electrical device, the basic portion having a second holding recess at a second end thereof opposite to the contact portion and coaxial with the first holding recess when the plunger is mounted to the barrel; and
an elastic element of a substantially normal column shape with a uniform diameter arranged inside the barrel, two ends of the elastic element being respectively received within and held by the first holding recess and the second holding recess to shorten an unrestrained part of the elastic element, for reducing a resilient distortion of the elastic element when the plunger resists the outer electrical device.

2. The probe connector as claimed in claim 1, wherein the first holding recess extends into the base with a predetermined distance.

3. The probe connector as claimed in claim 1, wherein the second holding recess extends into the contact portion with a predetermined distance.

4. The probe connector as claimed in claim 1, wherein the contact portion is thinner than the basic portion, the main body has a portion away from the base bent inwards to form a shoulder for restricting the basic portion within the barrel.
